(19) United States
(12) Patent Application Publication
(10) Pub. No.: US 2003/0206256 A1
(43) Pub. Date: Nov. 6, 2003

(54) Display device with backlight

(76) Inventors: Kieran F. Drain, New Hall, CA (US); Yukihiko Sasaki, Claremont, CA (US)

Correspondence Address: Jonathan A. Platt, Renner, Otto, Boisselle & Sklar, LLP, Nineteenth Floor, 1621 Euclid Avenue, Cleveland, OH, 44115-2191, US

(21) Appl. No.: 10/139,456

(22) Filed: May 6, 2002

(51) Int. Cl. G02F 1/1335

(52) U.S. Cl. 349/113

(57) ABSTRACT

A display device includes a light control device, and a backlight having a panel with one or more light management features. The light control device may be a liquid crystal display (LCD), for example having a plurality of picture elements, such as pixels, selectively activatable to allow or black transmission of light through the LCD. The light management features may include one or more features such as a brightness enhancement film, a transflective film, and/or a polarizing film. The backlight has a light emitting structure that may include an electroluminescent structure, such a small molecule organic light emitting device (SMOLED) or a polymer light emitting device (PLED). The electroluminescent structure of the backlight provides good illumination of the light control device at low voltage and low power, and the inclusion of the one or more light management features in the backlight may result in reduction of size, cost, and/or weight of the display device.

### BACKGROUND OF THE INVENTION

1. Technical Field of the Invention

The invention relates to optical display devices, and to methods for making the same.

2. Background of the Related Art

Display devices such as liquid crystal displays (LCDs) are commonly used for displays for many electronic devices such as personal digital assistants (PDAs), cellular phones, and laptop computers, all applications where light weight, low power and a flat panel display are desired. An LCD is essentially a light switching device that does not emit any light on its own. LCDs may be divided into three types: reflective, transflective and transmissive. Reflective LCDs use ambient light, and require no backlighting. However, transmissive and transflective LCDs require a backlight or backlights. Reflective LCDs are normally used for portable devices such as PDAs and cellular phones, while laptop computers use mostly transmissive LCD.

In conventional backlit LCDs, the backlights are cold cathode fluorescent lamps (a linear light source) or inorganic light emitting diodes (LEDs, a point light source). Both of these types of backlights are placed at edges of the display. The area of the display to be lit is a two-dimensional area. The point and linear light sources are guided by light guiding pipes, which convert point source light to linear light, and by light guiding plates, which convert linear source light to light over a two-dimensional area, to thereby illuminate the two-dimensional display area. The use of the light guiding pipes and plates may have several shortcomings, such as loss of light and lack of uniformity. The use of the conventional backlights makes the LCD devices thicker due to the bulkiness of the light source and light guiding parts. In addition, the use of the rigid light pipes and light guiding plate makes the construction rigid, so that even when flexible plastic substrates are used for the LCD, the resulting display may not be flexible.

Another option for backlights is the use of inorganic electroluminescent materials. They may provide thin (around 100 μm) and flat two-dimensional light sources. However, inorganic electroluminescent materials may require very high voltages (such as 90 to 100 volts AC), voltages which portable electronic devices normally cannot provide.

It would be desirable to produce display devices with improved backlights.

### SUMMARY OF THE INVENTION

According to an aspect of the invention, a display device includes a light control device having a plurality of picture elements, and a backlight coupled to the light control device. The backlight includes a first panel that includes at least one light management feature, a second panel sealingly adhered to the first panel, and a light emitting structure between the first and second panels.

According to another aspect of the invention, a method of making a display device includes the steps of forming a backlight and coupling the backlight to a light control device. The forming the backlight includes forming a light management feature on a first panel; forming a light emitting structure; and adhering a second panel to the first panel, with the light emitting structure therebetween.

According to yet another aspect of the invention, a display device includes a light control device having a plurality of picture elements, and a backlight coupled to the light control device. The backlight includes a first panel that includes a first light management feature; a second panel that includes a second light management feature, wherein the second panel is sealingly adhered to the first panel; and a light emitting structure between the first and second panels.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an exploded isometric view of a display device according to the present invention;

FIG. 2 is a cross-sectional view of the display device of FIG. 1;

FIG. 3 is a cross-sectional view of an embodiment of the display device of FIG. 1;

FIG. 4 is a cross-sectional view of an embodiment of a top panel incorporating a brightness enhancement film, for use in the display device of FIG. 1;

FIG. 5 is an isometric view of one configuration of the top panel of FIG. 4;

FIG. 6 is an isometric view of another configuration of the top panel of FIG. 4;

FIGS. 7 and 8 are cross-sectional views of embodiments of a top panel incorporating multiple brightness enhancement films, for use in the display device of FIG. 1;

FIGS. 9 and 10 are cross-sectional views of embodiments of a top panel that incorporates a transflective film, for use in the display device of FIG. 1;

FIGS. 11 and 12 are cross-sectional views of embodiments of a top panel that incorporates a polarizing film, for use in the display device of FIG. 1;

FIG. 13 is a cross-sectional view of an embodiment of a bottom panel that incorporates a reflective film;

FIG. 14 is a cross-sectional view of an embodiment of a top panel that includes spacers between the top panel and the light emitting structure, the top panel being for use in the display device of FIG. 1;

FIG. 15 is an illustration of a machine that may be used to produce the protrusions of FIGS. 4-8 on the top panel of the display device of FIG. 1;

FIG. 16 is an illustration of an embossing machine that may be used to produce the protrusions of FIGS. 4-8 on the top panel of the display device of FIG. 1; and

FIG. 17 is a cross-sectional view of illustrating one form of prior art sliding seal that may be used in the continuous press of FIG. 16.

### DETAILED DESCRIPTION

A display device includes a light control device, and a backlight having a panel with one or more light management features. The light control device may be a liquid crystal display (LCD), for example having a plurality of picture elements, such as pixels, selectively activatable to allow or block transmission of light through the LCD. The light management features may include one or more features such as a brightness enhancement film, a transflective film, a reflective film, and/or a polarizing film. The backlight has a light emitting structure that may include an electroluminescent structure, such a small molecule organic light emitting device (SMOLED) or a polymer light emitting device (PLED). The electroluminescent structure of the backlight provides good illumination of the light control device at low voltage and low power, and the inclusion of the one or more light management features in the backlight may result in reduction of size, cost, and/or weight of the display device.

Referring to FIG. 1, a display device 10 includes a light control device 12 and a backlight assembly 14. The backlight assembly 14 includes a top panel 16 with a light management feature 18 thereon or therein, and a bottom panel 20. A light emitting structure 22 is on the bottom panel 20, between the top panel 16 and the bottom panel 20. The term “top” and “bottom” are used herein for convenience, and it will be appreciated that the panels 16 and 20 may have other orientations, if desired. A sealant ring 24 attaches the top panel 16 and the bottom panel 20 together,

The light control device 12 may be a liquid crystal display (LCD), such as a pixelated LCD. The LCD may have any of a variety of well-known structures for LCDs. For example, the LCD may have a pair of LCD substrates, each having one or more electrodes thereupon, with liquid crystal material between the electrodes. The LCD may be a passive matrix design, with (for example) row electrodes on one of the LCD substrates and column electrodes on the other of the LCD substrates. Conventional driving electronics may be used in activating row and column electrodes corresponding to a pixel of the LCD to be activated, in a suitable addressing scheme. In some addressing schemes, the electrodes are sequentially and repeatedly scanned at a rapid rate to provide moving images similar to television images. This requires “refreshing” the display at short time intervals to rapidly turn pixels on and off.

Alternatively, the LCD may be an active matrix device, with driving electronics to activate each of a plurality of separate thin film transistors (TFTs), with each of the TFTs conventionally corresponding to a single pixel of the display.

Substrates of the LCD or other light control device 12 may be flexible films, such as a polymeric film substrate. Alternatively or in addition, one or both substrates may be made of an optically-transparent thermoplastic polymeric material. Examples of suitable such materials are polycarbonate, polyvinyl chloride, polystyrene, polymethyl methacrylate, polyurethane polyimide, polyester, and cyclic polyolefin polymers. More broadly, the substrates may include a flexible plastic such as a material selected from the group consisting of polyether sulfone (PES), polyethylene terephthalate (PET), polyethylene naphthalate, polycarbonate, polybutylene terephthalate, polyphenylene sulfide (PPS), polypropylene, aramid, polyamide-imide (PAI), polyimide, aromatic polyimides, polyetherimide, acrylonitrile butadiene styrene, and polyvinyl chloride. Further details regarding substrates and substrate materials may be found in International Publication Nos. WO 00/46854, WO 00/49421, WO 00/49658, WO 00/55915, and WO 00/55916, the entire disclosures of which are herein incorporated by reference in their entireties.

Alternatively, one or both of the substrates may be made of a rigid material. For example, one or both of the substrates may be a glass substrate. The glass may be a conventionally-available glass, for example having a thickness of approximately 0.2-1 mm. Alternatively, other suitable transparent materials may be used, such as a rigid plastic or a plastic film. The plastic film may have a high glass transition temperature, for example above about 65 degrees C., and may have a transparency greater than 85% at 530 nm.

The electrodes for the LCD or other light control device 12 may include commonly-known transparent conducting oxides, such as indium tin oxide (ITO). Other suitable metal oxides may be employed, such as indium oxide, titanium oxide, cadmium oxide, gallium indium oxide, niobium pentoxide, and tin oxide. In addition to a primary oxide, the electrodes may include a secondary metal oxide such as an oxide of cerium, titanium, zirconium, hafnium, and/or tantalum. The possible transparent conductive oxides include ZnO₂, Zn₂SnO₄, Cd₂SnO₄, Zn₂In₂O₅, MgIn₂O₄, Ga₂O₃-In₂O₃, and TaO₃. The electrodes may be formed, for example, by low temperature sputtering or direct current sputtering techniques (DC-sputtering or RF-DC sputtering), followed by selective removal of material.

In an exemplary embodiment, the electrodes may each have a width of 200 microns, with a 20 micron gap between electrodes, thus resulting in a display having pixels that are 200 microns by 200 microns in size, although it will be appreciated that other electrode sizes and gap sizes may be employed. The electrodes may have a sheet resistance of less than about 60 ohms.

The LCD may have other conventional layers, such as one or more alignment coatings to encourage a desired orientation of liquid crystal material in contact therewith, and a barrier layer that prevents moisture and oxygen from being transported through the display, thereby protecting layers underneath from environmental damage caused by exposure to oxygen and/or water. The alignment coatings may include a variety of well-known polymeric materials, for example a polyimide which can be spin coated or printed from solvent, and (if necessary) rubbed with cloth, such as velvet, to provide a useful alignment layer. The moisture and oxygen barrier may be a conventional suitable material, such as SiO₂. Alternatively, the barrier may be SiOₓ, where 1<×<2. Using SiOₓ instead of SiO₂ may provide an additional moisture and oxygen barrier for the display 10, better preventing moisture and oxygen from being transported through the display. The value x for the SiOₓ may be controlled, for example, by controlling the oxide ratio in the material used in sputtering the oxide layer, by adding oxygen to an SiO material.

The liquid crystal material of the LCD may include any of a wide variety of suitable liquid crystal materials, such as twisted nematic, cholesteric, and ferroelectric materials.

The light control device may be a suitable device other than an LCD, which allows light to fully or partially pass therethrough, and which allow portions (such as pixels) of the device to be rendered opaque and/or to change color.

The light management feature 18 on or in the top panel 16 may include one or more of the following features: a brightness enhancement film, a transflective film, and a polarizing film. Thus, as explained in greater detail below, the light management feature 18 may be integrated with the top panel 16, such that the top panel 16 may be manufactured with the light management feature 18 therein or thereupon.

Other light management features may also be included in the backlight assembly 14. For example, the bottom panel 20 may have one or more light management features such as a brightness enhancement film, a transflective film, a reflective film, and a polarizing film.

The sealant ring 24 may be made of a conventional suitable sealant material that may be used for adhering the panels 16 and 20 together, and for protecting the light emitting structure 22 from contaminants. For example, the sealant ring 24 may include an epoxy resin. It will be appreciated that the sealant ring 24 may be applied to either of the panels 16 and 20, prior to adhering the panels 16 and 20 together.

The light emitting structure 22 is described above as connected to the bottom panel 20. However, it will be appreciated that alternatively all or a part of the light emitting structure may be adhered to the top panel 16.

The light emitting structure 22 may be an electroluminescent structure, such a small molecule organic light emitting device (SMOLED) or a polymer light emitting device (PLED). As described in greater detail below, the light emitting structure may include multiple layers of various materials, for example including an anode, a hole transport layer, an emissive layer (emitter), and a cathode. The light emitting structure may also include other layers, such as a hole injection layer and/or an electron transport layer. Some of these layers may be suitably combined. For example, emissive material may be embedded in the electron transport layer.

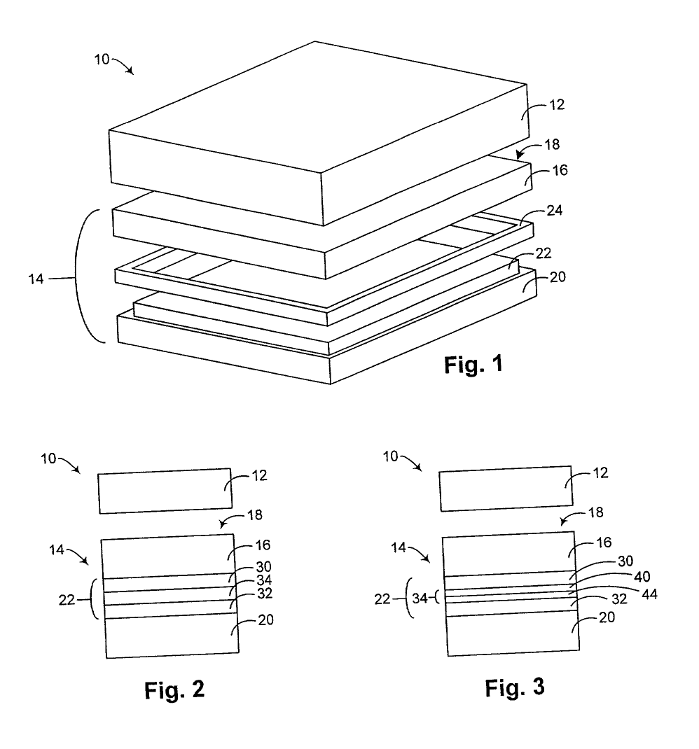

Turning to FIG. 2, details of one embodiment of the light emitting structure 22 are shown. The light emitting structure 22 shown in FIG. 2 includes an anode 30 and a cathode 32, with a light emitting material 34 between the anode 30 and the cathode 32. As noted above, the light emitting material 34 may include a hole transport material and an emitter. When a sufficiently large voltage is applied across the light emitting material 34 by the anode 30 and the cathode 32, electrons are ejected from one of the electrodes (the cathode 32) and holes are emitted from the other of the electrodes (the anode 30). The electron-hole combinations are unstable, and combine in the emitter to release energy in the form of light.

The electrodes 30 and 32 may be made from the transparent electrode materials described above. Examples of transparent, low work function electrodes may be found in U.S. Pat. No. 6,150,043, which is incorporated herein by reference in its entirety. Alternatively, some of the electrodes 30 and 32 may be opaque electrodes, such as copper or aluminum electrodes. More broadly, the electrodes may be elemental metal electrodes (opaque or transparent) that contain silver, aluminum, copper, nickel, gold, zinc, cadmium, magnesium, tin, indium, tantalum, titanium, zirconium, cerium, silicon, lead, palladium, or alloys thereof. Metal electrodes on plastic film have the advantage of higher conductivity than ITO electrodes on film.

The light emitting material 34 may include any of a variety of suitable materials, such as semiconductor materials; organic compounds such as small molecule compounds or conjugated polymers that have many of the characteristics of semiconductors; and suitable polymers such as poly-paraphenylene vinylene (PPV). For a SMOLED, the hole transport material may have a thickness from 100 to 500 Angstroms, and the emitter may have a thickness from 50 to 100 Angstroms. Further detail on suitable materials may be found in U.S. Pat. No. 5,703,436 and in U.S. Pat. No. 5,965,280, both of which are incorporated by reference in their entireties.

In the embodiment shown in FIG. 2 and described above, the cathode 32 is adhered to the bottom panel 20, with the anode 30 further from the bottom panel 20 and closer to the top panel. However, it will be appreciated that alternatively the configuration of the anode and the cathode may be reversed, as in embodiments described below.

The electrodes 30 and 32 and the light emitting material 34 may form a single light emitting element, without any patterning of the electrodes 30 and 32 and the light emitting material 34. However, it will be appreciated that alternatively multiple light emitting elements may be used.

The light emitting material may be a single layer of monochromatic material. Alternatively, the light emitting material may include multiple layers of different materials, for example with each of the materials emitting a different color of light. As another alternative, the light emitting material may include multiple materials, each emitting a different color of light, in a side-by-side arrangement. For example, the light emitting material may include alternating stripes of red-, blue-, and green-emitting materials.

As another alternative, the light emitting material may include one or more light emitting polymers (LEPs). For example, the light emitting material may include multiple LEPs selected for optimum light emission in a desired range, for example being optimized for emission of white light. The blend of LEPs may be a miscible blend of LEPs. Alternatively, the blend of LEPs may be an immiscible blend of LEPs, with each of the LEPs emitting a different color, and the LEPs collectively emitting white light.

Both of the panels 16 and 20 may be made of one or more suitable flexible substances. One or both of the panels 16 and 20 may include transparent substrates. Forming the panels from flexible substances allows the panels to be formed and combined using suitable roll forming operations, described in greater detail below. In addition, the resulting backlight assembly 14 may itself be flexible Thus the panels 16 and 20 may include thermoplastic materials such as polycarbonate, PET, or PES; may include thermoset materials mode of crosslinked materials such as epoxy, acrylic, polyurethane, and polyimide; or may utilize suitable materials from the list of substrate materials given above. n addition, the panel farthest from the light control device 12 may be opaque or reflective. Thus, in the embodiment shown in FIG. 2, the bottom panel 20 may have a light management feature such as a opaque coating or a reflective film adhered to it. For example, the bottom panel 20 may have a metal coating or be a polymer-metal laminate. Suitable barrier coatings may be applied if plastic material is used in the panels, to prevent passage of oxygen and/or moisture through the plastic panels.

Alternatively, the panel closest to the light control device 12 may be made of a transparent, flexible substance, with the panel farthest from the light control device 12 being made of a rigid substance. Further, it will be appreciated that electrodes closest to the light control device will be transparent, to allow light from the light emitting material 34 to reach the

The electrode closest to the light control device 12 (as illustrated, the anode 30) is a transparent electrode, such as an ITO electrode or an electrode composed of silver or silver alloy. Formation of such transparent electrodes is described further in U.S. Pat. No. 5,667,853, which is incorporated herein by reference in its entirety. The electrode farthest from the light control device (as illustrated, the cathode 32) may be a low work function electrode material, for example including Ca or Mg.

The voltage for operation of an SMOLED or PLED electroluminescent backlight device with a light emitter that includes organic material, such as may have the structure shown in FIG. 2, may be less than about 10 volts. This is a significant reduction compared to the 90 to 100 volts AC that may be required for electroluminescent backlight devices with inorganic light emitters.

Referring now to FIG. 3, in a particular embodiment the light emitting material 34 is that of a polymer light emitting device (PLED). The light emitting material 34 includes a hole transport layer 40 and a light emitting polymer (LEP) 44. The hole transport layer 40 may include PEDOT/PSS material (polyethylene dioxy thiophene/polystyrene sulphonate), and may have a thickness from 20 to 60 nm. The LEP 44 may include poly(phenylene vinylene) derivatives, and may have a thickness of less than 200 nm.

A potential difference between the anode 30 and the cathode 32 causes flow of electrons through the light emitting material 34, which causes the LEP 44 to emit light. This light passes through the transparent anode 30 and the top panel 16, thereafter passing through transparent portions of the light control device 12.

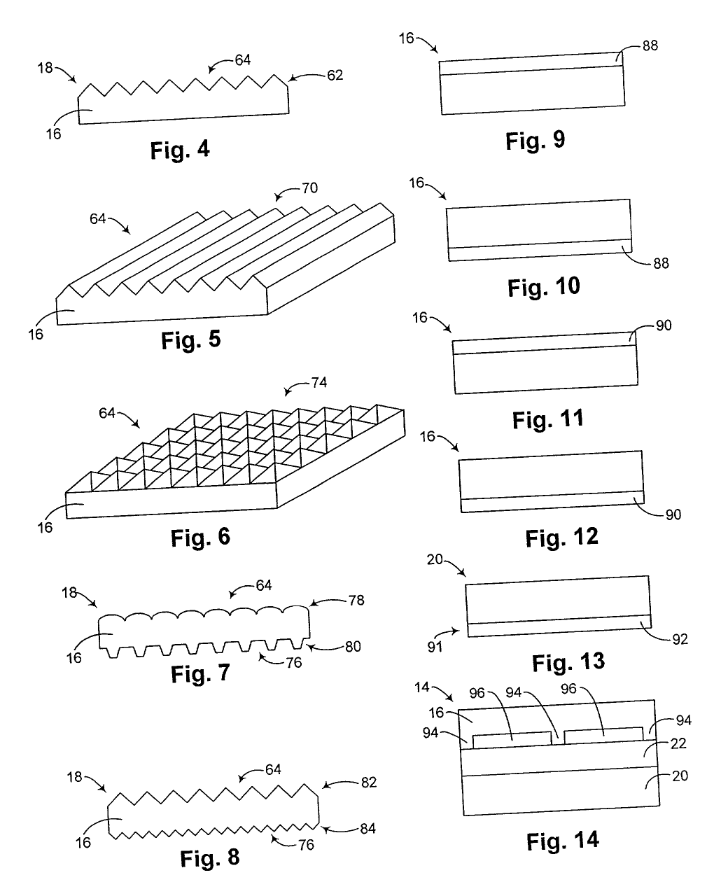

Turning now to FIGS. 4-6, in one embodiment the light management feature 18 is a brightness enhancement film 62 formed on the top panel 16 and integrated into the top panel 16. The brightness enhancement film 62 includes a plurality of periodically-arrayed protrusions 64. The protrusions 64 may be prisms. As shown in FIG. 5, the protrusions 64 may be two-dimensional prismatic structures 70, bars with triangular cross sections. Example of such structures are those described in U.S. Pat. No. 6,091,547, which is incorporated herein by reference in its entirety. As stated in U.S. Pat. No. 6,091,547, the prismatic structures 70 may have a pitch spacing of 1-30 μm, 2-20 μm, or 2-10 μm. Alternatively, as shown in FIG. 6, the protrusions 64 may be, in whole or in part, three-dimensional prisms or pyramids 74. Such three-dimensional pyramidal structures are shown in U.S. Pat. No. 6,277,471, which is incorporated herein by reference in its entirety.

It will be appreciated that the protrusions 64 of the brightness enhancement film 62 may have other suitable shapes. For example, the protrusions 64 may spherical microlenses, such as described in U.S. Pat. No. 5,521,725, which is incorporated herein by reference in its entirety. Alternatively, the protrusions 64 may be prisms having distal ends wider than their proximate ends in contact with the rest of the top panel 16. Such protrusions are also shown and described in U.S. Pat. No. 5,521,725. Another potentially suitable protrusion shape is the rhomboidal cross-section shape protrusion also shown and described in U.S. Pat. No. 5,521,725. Other suitable protrusion shapes are described in U.S. Pat. Nos. 5,428,468, 5,600,462, and 5,748,828, all of which are incorporated by reference in their entireties.

Referring to FIGS. 7 and 8, the top panel 16 may have multiple brightness enhancement films, with first protrusions 64 on one of its surfaces, and second protrusions 76 on an opposite of its surfaces. The first protrusions 64 may differ from the second protrusions 76 in size, shape, and/or orientation. For example, as shown in FIG. 7, the first protrusions 64 may be spherical microlenses 78, and the second protrusions 76 may be two-dimensional trapezoidal structures 80. FIG. 8 shows another example, wherein the first protrusions 64 are first bars 82 with a triangular cross-section that is larger than the triangular cross-section of second bars 84 that constitute the second protrusions 76.

FIGS. 9 and 10 show another embodiment light management feature 18 in the top panel 16, a transflective film 88. The transflective film 88 may be a partially mirrored surface of the top panel 16. The partially mirrored surface allows the display 10 to make use of ambient light in high-ambient-light situations, essentially functioning as a reflective display device in such situations, with the transflective film 88 reflecting at least part of the incident light. In low-ambient-light situations, however, the backlight assembly 14 provides illumination for the light control device 12, allowing the display 10 to function as a transmissive device. Selective powering of the backlight assembly 14, depending on external light conditions, reduces overall power consumption.

The transflective film 88 may be on a top side of the top panel 16, nearest to the light control device 12, as is shown in FIG. 9. Alternatively, as shown in FIG. 10, the transflective film 88 may be on a bottom side of the top panel 16, the side away from the light control device 12.

As mentioned above, the transflective film 88 may be a partially mirrored surface of the top panel 16. Alternatively, it will be appreciated that the transflective film 88 may another suitable type of transflective film. Further information regarding transflective films may be found in U.S. Pat. No. 6,262,842, which is incorporated herein by reference in its entirety.

Turning now to FIGS. 11 and 12, yet another embodiment light management feature 18, a polarizing film 90, is shown as part of the top panel 16. The polarizing film 90 may be on a top surface of the top panel (FIG. 11) or may be on a bottom surface of the panel 16 (FIG. 12).

Rather than being separate parts of the top panel 16, it will be appreciated that alternatively the entire top panel 16 may be a polarizing film.

Other suitable light management features may also be included in the top panel 16. For example, the top panel may be or may include a light diffusing film.

Various of the light management features 18 described above may be suitably combined in a single top panel 16. For example, the top panel 16 may have both a brightness enhancement film 62 and a transflective film 88. One of the multiple light management features may on one side of the top panel 16 may be on the opposite side of the top panel 16. Other suitable combinations and arrangements of light management features may be employed. In addition, the display device 10 may include additional light management features that are not a part of the top panel 16, and may not be a part of the backlight assembly 14.

The top panel 16 of the various embodiments of the display device 10 described above will generally be made of a light transmissive material to allow light from the light emitting structure 22 to pass therethrough, and into the light control device 12. The top panel 16 may thus be substantially transparent. The bottom panel 20 may be transparent, opaque, or partially transmissive, allowing some but not all of light reaching it to pass through. Opaqueness of the bottom part of the backlight assembly 14 may accomplished in any of a variety of ways. For example, the bottom panel 20 may be made of an opaque material, such as a suitable opaque polymer material, for example one of the transparent polymer materials discussed above to which a dye or other pigmentation is added. Alternatively, the bottom panel 20 may include an opaque material layer, which may be a polymer that is the same as or different than the transparent polymer of the remainder of the bottom panel 20. .

Alternatively or in addition, as noted above, the electrode material for the cathode 32 itself may be opaque. For example, the electrode material may be aluminum or copper, which is opaque when deposited on the polymer substrate material. The depositing of the electrode material may be by sputtering, for example.

Also as noted above, a suitable opaqueness may alternatively be achieved by printing an opaque ink between all or a portion of the bottom panel 20 and the cathode 32.

It will be appreciated that, as an alternative arrangement, the backlight 14 may be reversed, such that the bottom panel 20 is next to the light control device 12, and the top panel 16 is further away from the light control device 12. In such an arrangement, the bottom panel 20 would be made of a light transmissive material, and may have one or more light management features formed thereon or therein.

As a further alternative, the top panel 16 and the bottom panel 20 may both be light transmissive, with each of the panels including one or more light management features such as the light management features 18 discussed above. Both of the electrodes 30 and 32 of such a device may be light transmissive. Such a device may be used in situations where it is desirable to illuminate both sides of the device 10, which may not necessarily be employed as a backlight. For example, two-directional light device could be used to illuminate a two-sided sign.

FIG. 13 shows an alternative bottom panel 20, with a light management feature 91 thereupon. The light management feature 91 is a reflective film 92, which may be formed on either side of the substrate material of the bottom panel 20. The reflective film 92 may serve to reflect light emanated from the light emitting structure 22, such that the amount of light passing out of the backlight out of the backlight assembly 14 through the top panel 16. The reflective film 92 may be either a sheet or layer of separate reflective material, or may be a coating of reflective material.

FIG. 14 shows another embodiment of the backlight assembly 14, in which the top panel 16 includes spacers 94 on a bottom side facing the light emitting structure 22. The spacers 94 reduce contact between the top panel and the light emitting structure 22. Gaps 96 between the top panel 16 and the light emitting structure 22 may be filled with an inert gas, so as to insure a large difference in refractive indices for light traveling from the light emitting structure 22 to the top panel 16.

The spacers 94 may be evenly spaced along the bottom surface of the top panel 16, and may have any of a variety of suitable shapes. The spacers 94 may be combined with one or more of the light management features described above. The spacers 94 may be of a shape that allows them to function as a brightness enhancement film. Thus the spacers 94 may have one or more of the suitable shapes for the protrusions 64 that were discussed above.

The protrusions 64 and/or the spacers 94 may be physically and chemically integral to the top panel 16, and may be formed by a microreplication process. One technique of microreplicating arrays with very small surfaces requiring a high degree of accuracy is found in the use of continuous embossing to form cube corner sheeting. A detailed description of equipment and processes to provide optical quality sheeting are disclosed in U.S. Pat. Nos. 4,486,363 and 4,601,861. Tools and a method of making a tool used in those techniques are disclosed in U.S. Pat. Nos. 4,478,769; 4,460,449; and 5,156,863. The disclosures of all the above patents are incorporated herein by reference.

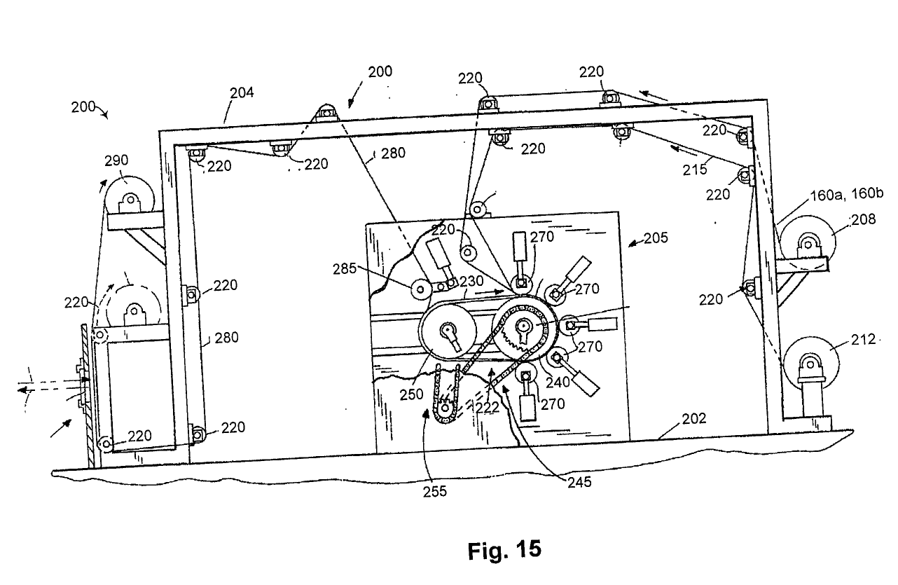

A machine 200 for producing a substrate such as that described above is shown in elevation in FIG. 15, suitably mounted on a floor 202. The machine 200 includes a frame 204, centrally located within which is an embossing means 205.

A supply reel 208 of unprocessed thermoplastic web 160a, 160b is mounted on the right-hand side of the frame 204; so is a supply reel 212 of flexible plastic film 215. An example of a suitable flexible plastic film 215 is a PET film available from DuPont, which is heat stabilized and has a glass transition temperature of 78 degrees C and a use temperature of up to 120 degrees C. The flat web 160a, 160b and the film 215 are fed from the reels 208 and 212, respectively, to the embossing means 205, over guide rollers 220, in the direction of the arrows.

The embossing means 205 includes an embossing tool 222 in the form of an endless metal belt 230 which may be about 0.020 inches (0.051 cm) in thickness. The width and circumference of the belt 230 will depend in part upon the width or material to be embossed and the desired embossing speed and the thickness of the belt 230. The belt 230 is mounted on and carried by a heating roller 240 and a cooling roller 250 having parallel axes. The rollers 240 and 250 are driven by chains 245 and 255, respectively, to advance belt 230 at a predetermined linear speed in the direction of the arrow. The belt 230 is provided on its outer surface with a continuous female embossing pattern 260 that matches the general size and shape of the particular protrusions to be formed in the web 160a, 160b.

Evenly spaced sequentially around the belt, for about 180° around the heating roller 240, are at least three, and as shown five, of pressure rollers 270 of a resilient material, preferably silicone rubber, with a durometer hardness ranging from Shore A 20 to 90, but preferably, from Shore A 60 to 90.

While rollers 240 and 250 may be the same size, in the machine 200 as constructed, the diameter of heating roller 240 is about 10.5 inches (26.7 cm) and the diameter of cooling roller 250 is about 9 inches (22.9 cm). The diameter of each pressure roller 270 is about 6 inches (15.2 cm).

It may be desirable to maintain additional pressure about the tool and substrate during cooling, in which case the cooling roller 250 could be larger in diameter than the heating roller, and a plurality of additional pressure rollers, (not shown) also could be positioned about the cooling roller.

Either or both heating roller 240 or cooling roller 250, has axial inlet and outlet passages (not shown) joined by an internal spiral tube (not shown) for the circulation therethrough of hot oil (in the case of heating roller 240) or other material (in the case of cooling roller 250) supplied through appropriate lines (not shown).

The web 160a, 160b and the film 215, as stated, are fed to the embossing means 205, where they are superimposed to form a laminate 280 which is introduced between the belt 230 and the leading roller of the pressure rollers 270, with the web 160a, 160b between the film 215 and the belt 230. From thence, the laminate 280 is moved with the belt 230 to pass under the remaining pressure rollers 270 and around the heating roller 240 and from thence along belt 230 around a substantial portion of cooling roller 250. Thus, one face of web 160a, 160b directly confronts and engages embossing pattern 260 and one face of the film 215 directly confronts and engages pressure rollers 270.

The film 215 provides several functions during this operation. First, it serves to maintain the web 160a, 160b under pressure against the belt 230 while traveling around the heating and cooling rollers 240 and 250 and while traversing the distance between them, thus assuring conformity of the web 160a, 160b with the precision pattern 260 of the tool during the change in temperature gradient as the web (now embossed substrate) drops below the glass transition temperature of the material. Second, the film 215 maintains what will be the outer surface of substrate in a flat and highly finished surface for other processing, if desired. Finally, the film 215 acts as a carrier for the web 160a, 160b in its weak “molten” state and prevents the web from adhering to the pressure rollers 270 as the web is heated above the glass transition temperature.

The embossing means 205 finally includes a stripper roller 285, around which laminate 280 is passed to remove the same from the belt 230, shortly before the belt 230 itself leaves cooling roller 250 on its return path to the heating roller 240.

The laminate 280 is then fed from stripper roller 285 over further guiding rollers 220, eventually emerging from frame 204 at the lower left hand corner thereof. Laminate 280 is then wound onto a storage winder 290 mounted on the outside of frame 204 at the left hand end thereof and near the top thereof. On its way from the lower left hand corner of frame 204 to winder 290, additional guiding rollers guide the laminate 280.

The heating roller 240 is internally heated (as stated above) so that as belt 230 passes thereover through the heating station, the temperature of the embossing pattern 260 at that portion of the tool is raised sufficiently so that web 160a, 160b is heated to a temperature above its glass transition temperature, but not sufficiently high as to exceed the glass transition temperature of the film 215.

The cooling roller 250 is internally “fueled” (as stated above) so that as belt 230 passes thereover through the cooling station, the temperature of the portion of the tool embossing pattern 260 is lowered sufficiently so that web 160a, 160b is cooled to a temperature below its glass transition temperature, and thus becomes completely solid prior to the time laminate 280 is stripped from tool 230.

It has been found that the laminate 280 can be processed through the embossing means 205 at the rate of about 3 to 4 feet per minute, with satisfactory results in terms of the accuracy and dimensional stability and other pertinent properties of the finished substrate.

It will further understood that temperatures of the heating roller and cooling rollers may need to be adjusted within certain ranges depending upon the web material selected. Certain materials have higher glass transition temperature T_{G} than others. Others may require cooling at a higher temperature then normal and for a longer time period. Preheating or additional heating at the entrance of the nips may be accomplished by a laser, by flameless burner, or by another device, and/or by adjusting the temperature of the heating roller to run at higher preselected temperature. Similar adjustments may be made at the cooling level.

A preferred material for the embossing tool disclosed herein is nickel. The very thin tool (about 0.010 inches (0.025 cm) to about 0.030 inches (0.076 cm)) permits the rapid heating and cooling of the tool 230, and the web 160a, 160b, through the required temperatures gradients while the pressure rolls and the carrier film apply pressure. The result is the continuous production of a precision pattern where flatness and angular accuracy are important while permitting formation of sharp corners with minimal distortion of other surfaces, whereby the finished substrate provides an array of protrusions (such as the protrusions 64 and/or the spacers 94) formed with high accuracy.

The embossing means described herein, with suitable modifications of the tooling, substrate materials and process conditions, may be used to produce the top panel 16 with the protrusions 64 and/or the spacers 94.

An alternative method of forming the protrusions 64 and/or the spacers 94 is by printing UV-curable resins on a substrate, and then curing the resins to form the protrusions. An example of a suitable material is a matrix material commonly used in making color filters, such as the OPTIMER CR Series Pigment Dispersed Color Resist available from JSR Corporation of Japan. Another example of UV-curable resins is UV-curable epoxy acrylates. The printing may be accomplished by ink jet printing or screen printing, for example. Further information regarding ink jet printing and screen printing may be found in U.S. Pat. Nos. 5,889,084, and 5,891,520, the disclosures of which are incorporated herein by reference. Other methods of forming microstructures with UV-curable resins may be found in International Publication No. WO 99/08151.

A further method of forming the top panel 16 includes forming protrusions on a major surface of a substrate by a photolithography process. The photoresist for the photolithography process may be a matrix material of the type commonly used for producing color filters. A preferred material of this type is CSP series photo-sensitive rib materials by Fuji Film Olin Co., Ltd (Japan).

It will be appreciated that a structure or arrangement of the protrusions 64 and/or the spacers 94 may also be formed by any of a variety of suitable methods. For example, the above-described methods involving printing and curing UV-curable resins, and photolithography, may be utilized. As another alternative, a suitable embossing process may be used to form the arrangement of recesses and protrusions. A press for carrying out an embossing process on rigid substrates is described briefly below. Further details regarding embossing of rigid materials may be found in commonly-assigned, co-pending U.S. patent application Ser. No. 09/596,240, entitled “A Process for Precise Embossing”, filed Jun. 6, 2000, and in International Application No. PCT/US01/18655, filed Jun. 8, 2001. Both of these applications are incorporated herein by reference in their entireties.

Continuous presses include double band presses which have continuous flat beds with two endless bands or belts, usually steel, running above and below the product and around pairs of upper and lower drums or rollers. These form a pressure or reaction zone between the two belts and advantageously apply pressure to a product when it is flat rather than when it is in a curved form. The double band press also allows pressure and temperature to vary over a wide range. Dwell time or time under pressure is easily controlled by varying the production speed or rate, and capacity may be changed by varying the speed, length, and/or width of the press.

In use, the product is “grabbed” by the two belts and drawn into the press at a constant speed. At the same time, the product, when in a relatively long flat plane, is exposed to pressure in a direction normal to the product. Of course, friction is substantial on the product, but this may be overcome by one of three systems. One system is the gliding press, where pressure-heating plates are covered with low-friction material such as polytetrafluoroethylene and lubricating oil. Another is the roller bed press, where rollers are placed between the stationary and moving parts of the press. The rollers are either mounted in a fixed position on the pressure plates or incorporated in chains or roller “carpets” moving inside the belts in the same direction but at half speed. The roller press is sometimes associated with the term “isochoric.” This is because the press provides pressure by maintaining a constant distance between the two belts where the product is located. Typical isochoric presses operate to more than 700 psi.

A third system is the fluid or air cushion press, which uses a fluid cushion of oil or air to reduce friction. The fluid cushion press is sometimes associated with the term “isobaric” and these presses operate to about 1000 psi. Pressure on the product is maintained directly by the oil or the air. Air advantageously provides a uniform pressure distribution over the entire width and length of the press.

In double band presses, heat is transferred to thin products from the heated rollers or drums via the steel belts. With thicker products, heat is transferred from heated pressure plates to the belts and then to the product. In gliding presses, heat is also transferred by heating the gliding oil itself. In roller bed presses, the rollers come into direct contact with the pressure-heating plates and the steel belts. In air cushion presses, heat flows from the drums to the belts to the product, and, by creating turbulence in the air cushion itself, heat transfer is accomplished relatively efficiently. Also, heat transfer increases with rising pressure.

Another advantage of the double band press is that the product may be heated first and then cooled, with both events occurring while the product is maintained under pressure. Heating and cooling plates may be separately located one after the other in line. The belts are cooled in the second part of the press and these cooled belts transfer heat energy from the product to the cooling system fairly efficiently.

Continuous press machines fitting the general description provided hereinabove are sold by Hymmen GmbH of Bielefeld, Germany (U.S. office: Hymmen International, Inc. of Duluth, Georgia) as models ISR and HPL. These are double belt presses and also appear under such trademarks as ISOPRESS and ISOROLL. To applicants' knowledge, such presses heretofore have not generally been used to emboss precise recesses, especially with polymeric materials.

Continuous presses include several major variations in double band design. The press may include a single patterned belt to form a precision microstructure pattern on one surface of the resinous sheeting, or may include two such belts in order to emboss both sides of the sheeting. Each of the patterned belt(s) may be mounted to the continuous double band press as the only band or belt on that side of the press; or the patterned belt may be a secondary belt, which is mounted to a primary band on the press as further described below.

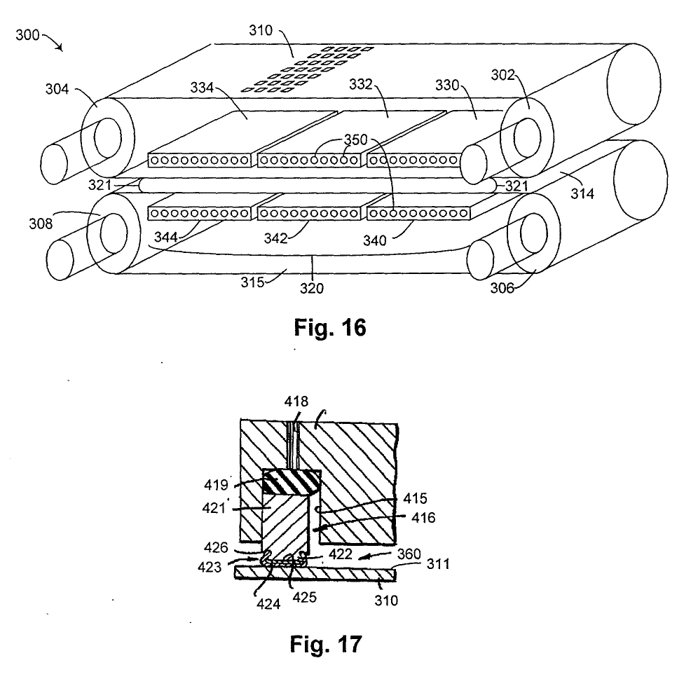

Referring now to FIG. 16, a continuous press 300 is diagrammatically illustrated. The press 300 includes a pair of upper rollers 302, 304 and a pair of lower rollers 306, 308. The upper roller 302 and the lower roller 306 may be oil heated. Typically the rollers are about 31.5 inches (80 cm) in diameter and extend for about 51 inches (130 cm). Around each pair of rollers is a belt typically of steel, but nickel is preferred for microstructure embossing.

An improved belt and method of making same is hereinafter described. An upper patterned belt 310 is mounted around the upper rollers 302, 304 and a lower plain surfaced belt 315 is mounted around the lower rollers 306, 308. The direction of rotation of the drums, and thus bands 310 and 315, is shown by the curved arrows. Heat and pressure are applied in a portion of the press referred to as the reaction zone 320, also defined between the bands by the brackets 321. Within the reaction zone are means for applying pressure and heat, such as three upper matched pressure sections 330, 332, 334 and three lower matched pressure sections 340, 342, 344. Each section is about 39 inches (80 cm) wide and approximately 51 inches (130 cm) long. Heat and pressure may be applied by other means as is well known by those skilled in the press art. Also, it is understood that the dimensions set forth are for existing continuous presses, such as those manufactured by Hymmen; these dimensions may be changed if found desirable.

The upper surface 314 of lower belt 315 may be smooth if only one side of the film is to be embossed with features. For optical products, the belt may be embossed such that the back surface takes on the surface finish of any carrier film, and provides adequate smoothness. If both sides of the film are to be embossed, then both the upper belt 310 and the lower belt 315 will be provided with the inverse of the topography to be embossed.

It is to be understood that each of the pressure sections may be heated or cooled; i.e., the temperature of each press section can be independently controlled. Thus, for example, the first two upstream pressure sections, upper sections 330, 332 and the first two lower sections 340, 342 may be heated whereas the downstream sections 334 and 344 may be cooled or maintained as a relatively constant but lower temperature than the heated sections. It will be observed from FIG. 16 that each of the pressure sections may have provisions for circulating heating or cooling fluids therethrough, as represented by the circular openings 350.

The process for embossing the thermoplastic film to precise microstructure formation consists of feeding a thermoplastic film (or extrudate resin) into the press 300; heating the material to an embossing temperature Tₑ above the glass transition temperature T_{g} (e.g. about 100° F. to 150° F/38° C. to 66° C. above that glass transition temperature); applying pressure of about 150-700 psi/1.03-4.83 MPa (e.g. 250 psi/1.7 MPa) to the film; cooling the embossed film at the cooling station which can be maintained below ambient temperature (e.g. at about 72° F.; 22° C.) and maintaining a pressure of about 150-700 psi/1.03-4.83 MPa (e.g. about 250 psi/1.7 MPa) on the material during the cooling step.

With the dimensions and reaction zones stated above, the process rate may move at about 21 to 32 feet (6.40 to 9.75 meters) per minute.

For a given size embossing belt, and press machine, the embossing goal is to maximize production. Other things equal, the design that uses more of the belt's length is better. Length might be used for forming or for cooling. At the maximum running speed, these two minimum times (forming and cooling) occupy all the available length. The minimum time (length) required for forming may be less than, equal to, or greater than the minimum time (length) required for cooling. The present equipment permits some variation of these distances by virtue of the pressure plate arrangements. Additional pre-heating of the film before entry to the reaction zone, or post-reaction zone cooling also may be provided, depending on the materials used.

In the embodiment of FIG. 16, the patterned belt(s) 310 (and possibly 315) is mounted to the rollers 302, 304 as the only band or belt on that side of the press. In isobaric double band presses such as that of Hymmen GmbH, the bands serve to seal in the pressurized fluid (oil or air), which can be under an elevated pressure as great as 1000 psi (6.9 MPa). This requires that the belt have adequate mechanical strength (tensile strength and yield strength) to withstand the high pressures.

The reaction zone 320, 321 is formed between the lower run of the upper press band 310 and the upper run of the lower press band 315 in which the material sheet or web is fed, which is of a synthetic thermoplastic resin.

The reaction zone pressure can be applied hydraulically to the inner surfaces of the endless press belts 310 and 315 by the opposing pressure plates 330, 332, 334, and 340, 342, 344 and is transferred from the belts to the film material fed therebetween. Reversing drums 302 and 306 arranged at the input side of the press are heated and, in turn, heat press belts 310 and 315. The heat is transmitted through the belts into the reaction zone where it is supplied to the film material. Similarly, the opposite reversing drums 304 and 308 may be arranged for additional cooling of the belts.

The pressing force is provided on the film material sheet in the reaction zone 320, 321 by a fluid pressure medium introduced into the space between the upper and lower pressure plates and the adjacent inside surfaces of the press belts located between the drums, which portions of the belts form the reaction zone. The space forming the so-called pressure chamber (exemplified for the lower belt as 260) is defined laterally by sliding seals. In order to avoid contamination of the film, desirably compressed air or other gases (as opposed to liquids) are used as the pressure medium in the pressure chamber of the reaction zone.

In the isobaric double band presses of Hymmen GmbH, in order to seal the highly pressurized air, the press includes cushion seals formed with highly smooth surfaces on the double bands. These provide a sliding seal to contain pressures of hundreds of pounds per square inch. In the case of a patterned belt 310, the sealing surface is the opposite face of the belt from that containing the precision microstructure pattern. If the continuous press includes an unpatterned band, likewise a very smooth surface finish is required that may be provided for example using a polished chrome surface of a stainless steel band. In the case of the Hymmen isobaric press, a surface finish of 0.00008-0.00016 inches (2-4 micron) R_{z} is required, which is equivalent to 80-160 microinch rms in English units. Cf. American National Standards Institute, “Surface Finish”, ANSI B46.1. Surface treatment techniques such as polishing, electropolishing, superfinishing and liquid honing, can be used to provide the highly smooth surface finishes of belts 310, 315.

FIG. 17 illustrates one form of prior art sliding seal 400 that may be used in the continuous press of FIG. 16. It is more completely described in U.S. Pat. No. 4,711,168. The edge or border of the press band 410 which is parallel with the forward running direction of the film, has a groove 415 running parallel to the border and containing a sliding seal 416. The sliding seal is arranged to be displaceable vertically relative to the inside surface 311 of the press belt 310 facing toward the upper pressure plates. The pressure within the pressure chamber 360 between the pressure plate 330, the inside surface 311 of the press belt 310 and the sliding seal 416 holds the sliding seal in contact with one of the inner walls of groove 415 (the left hand wall as viewed in FIG. 17), so that the seal is slidingly displaceable.

A borehole 418 opens into the base of the groove 415 so that the pressure source can act through the borehole 418 on an elastic O-ring 419 against the seal 416. In turn this presses against the inner surface 311 of the press belt 310 so that the pressure chamber is sealed against the ambient atmospheric side of the structure. The contact pressure of the seal against the press belt can be effected in other ways, for example by means of a spring.

The seal 416 further includes a body 421 formed of a metallic material preferably high tensile steel. The body is substantially rectangular with the addition of a profiled base 422. A sliding surface formed as a sliding cap 423 is fitted on and securely connected to the base 422. The sliding cap is formed of a composite material and includes a dry sliding layer 424 and a carrier layer 425. The carrier layer of the composite material may be a copper plated steel band which is particularly advantageous for the production of the sliding cap. Further details of this form of seal and its construction can be found with reference to U.S. Pat. No. 4,711,168, incorporated in full by reference.

Recesses 426 are formed in both sides of the body 421 at the transition with the base 422. The sliding cap 423 is secured to the base 422 with the carrier layer 425. The carrier layer 425 bearing against the base 422 with the dry sliding layer facing toward the inner surface 311 of the press belt 310 and with the opposite edges of the cap being fitted in to the recesses 426. Accordingly, the sliding cap 423 is firmly anchored to the base 422 by plastic deformation.

As discussed above, the embossing machine 200 shown in FIG. 14 would generally be suitable for use with relatively flexible materials, while the press 294 shown in FIG. 15 would generally be suitable for use with relatively rigid materials. The choice as to which type of microreplicating machine to employ may depend on the thickness and elasticity modulus of the material to be microreplicated. For example, polycarbonate has a modulus of elasticity of 10⁸ Pascals, as determined according to ASTM D882. Films of polycarbonate less than about 15 mils thick would preferably be run through a belt embosser, while films of polycarbonate greater than about 30 mils thick would preferably be run through a flat bed embosser. For materials with very low elasticity modulus, such as a rubbery foam, the upper limit of thickness for a belt embosser would be higher.

The backlight assembly 14 may be fabricated using a roll-to-roll process, with the top panel 16 and the bottom panel 20 formed from separate rolls of suitable substrate material. For example, a first roll of material may have the protrusions 64 and/or the spacers 94 formed on it, such as by the microreplication process described above. A second roll of material may have the light emitting structure 22 formed thereon, for example by sputter coating an electrode (such as the cathode 32) on the substrate, applying the light emitting material 34 on the cathode 32, and applying the anode 30 on the light emitting material 34. The sealant ring 24 may then be deposited around the light emitting material. The two rolls of material may be combined together in a suitable process, such as by lamination. The sealant may then be cured, for example by heat curing or by exposure to light of a suitable wavelength. Finally, a suitable process, such as cutting, may be employed to separate the individual backlight assemblies 14 from the rolls and from each other.

Possible processes for applying the electrodes 30 and 32 and/or the light emitting material 34 include sputtering, physical vapor deposition (PVD), spin coating, and ink jet printing and other suitable printing processes.

Other roll processes may be used in fabricating the backlight assembly 14. For example, the transflective film 88 or the polarizing film 90 may be laminated onto the roll material for the top panel 16. And the backlight assembly 14 may be suitably laminated to a roll of material of light control devices 12. A suitable adhesive may be used to attach the roll of backlight assemblies 14 to the roll of light control devices 12. The adhesive may be cured prior to separating the display devices 10 from the combined roll.

Alternatively, discrete bottom panels 20 may be coupled to a roll of the top panels 16 through a hybrid roll process, wherein the discrete bottom panels 20 are placed onto the roll of top panels 16, by a pick and place operation. For example, a web of front panels 16 may be formed as described above, and the bottom panels 20 may be formed by a handling process that utilizes sheets of material upon which multiple of the bottom panels 20 are formed. After formation of the light emitting structure 22 on the sheet, the individual top panels may be separated from the sheet. Thereafter, hybrid processing is performed to combine the bottom panels 20 with the web of the top panels 16. As stated above, the placement of the discrete bottom panels 20 on web (roll) of the top panels 16 may be accomplished by a pick and place operation. Known suitable mechanical and/or vacuum pick and place devices may be utilized in the pick and place operation.

In the sheet processing operations to form the discrete bottom panels 20, the light emitting structure 22 may be formed on the bottom panels 20 by suitable operations, such as those discussed above. After separation of the discrete bottom panels 20 from the sheets, the bottom panels 20 may be loaded into a magazine, for later retrieval in the pick and place operation.

It will be further appreciated that some or all of substeps of the forming of the bottom panels 20 may be performed other than as sheet processing operations.

In the combination of the discrete bottom panels 20 and the roll of the top panels by hybrid processing, the roll of the top panels 16 may be indexed at some or all of the processing stations in the roll processing. Initially in the hybrid processing, the roll of the top panels 16 may be unwound. Then, the position of the individual top panels 16 on the web (roll) may be registered, for example using a CCD camera to detect a registration or alignment mark on or near the top panel 16. Then the bottom panel 20 is removed from the magazine and placed on the top panel 16 in a pick and place operation. The bottom panels 20 may be advanced to the front of the magazine by a spring, and may be lightly retained for pick off by springy or mechanically retracting retainer fingers.

The pick and place operation may be performed by a pick and place device, which may include mechanical and/or vacuum grips to grip the bottom panel 20 while moving it into the desired location in alignment with the top panel 16. It will be appreciated that a wide variety of suitable pick and place devices are well known. Examples of such devices are the various devices disclosed and discussed in U.S. Pat. Nos. 6,145,901, and 5,564,888, both of which are incorporated herein by reference in their entireties. Alternatively, rotary placers may be utilized to place the bottom panel 20 upon the top panel 16. An example of such a device is disclosed in U.S. Pat. No. 5,153,983, the disclosure of which is incorporated herein by reference.

The registration of the top panel 16 may be coordinated with placement of the bottom panel 20 on the top panel 16. For example, the CCD camera and the pick and place device may be operatively coupled so as to insure alignment of the bottom panel 20 relative to the top panel 16 during and/or after the placement of the bottom panel 20 onto the top panel 16. It will be appreciated that use of the pick and place device allows greater accuracy in the placement of the bottom panel 20 relative to the top panel 16, when compared to joining of front and back panels roll-to-roll processes involving combining respective front and back panel rolls. Devices produced by combining front and back panels from respective rolls may be prone to errors in alignment, due to the variations in dimension which may occur during fabrication of the panels, variations in dimensions due to heating, stretching, and other processes involved in roll-to-roll fabrication.

It will be appreciated that the registration process may be omitted if the alignment is acceptable without registration.

It will be appreciated that the bottom panels 20 must be sufficiently rigid so as to maintain sufficient dimensional stability and stiffness throughout the pick and place and registration processes. If the bottom panels 20 are too limp, they may flutter during the pick and place operation, interfering with proper position of the bottom panels 20 relative to the top panel 16. As an example, a suitable Gurley stiffness of the front panels in the machine direction may be about 40 mg or greater. Further information regarding acceptable stiffness for pick and place operations may be found in U.S. Pat. No. 6,004,682, the specification of which is incorporated herein by reference.

Thereafter, the panels 16 and 20 may be bonded together, for example by spot curing an adhesive earlier applied one of the panels 16 and 20. The spot coating provides a way of quickly anchoring the panels 16 and 20 together, to maintain the desired relative alignment of the panels 16 and 20 during further processing steps.

The sealant rings 24 of the combined front and back panels then may be cured, such as by heating or by exposure to suitable radiation. The combined completed backlight assemblies 14 are cut and stacked, and may be combined with light control devices 12 to form displays 10.

It will be appreciated that alternatively the bottom panels 20 may be formed from a flexible material using one or more roll processes, and discrete top panels 16, for example being made of a rigid material, may be placed upon the roll of bottom panels 20 at suitable locations.

The fabrications steps and substeps described above are merely one example of the fabrication of a display, and it will be appreciated that the above-described method may be suitably modified by adding, removing, or modifying steps or substeps. For example, the display material alternatively may be deposited by printing, such as by ink jet printing or printing using a letterpress.

Displays of the sort described above may be coupled to other components as a part of a wide variety of devices, for display of various types of information. For example, a display may be coupled to a microprocessor, as part of a computer, electronic display device such as an electronic book, cell phone, calculator, smart card, appliance, etc., for displaying information.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A display device comprising:
a light control device having a plurality of picture elements; and
a backlight coupled to the light control device, wherein the backlight includes:
a first panel that includes at least one light management feature;
a second panel sealingly adhered to the first panel; and
a light emitting structure between the first and second panels.

2. The display device of claim 1, wherein the light emitting structure is formed upon the second panel.

3. The display device of claim 1, wherein the light emitting structure is formed upon the first panel.

4. The display device of claim 1, wherein the at least one light management feature includes a brightness enhancement film.

5. The display device of claim 4, wherein the brightness enhancement film includes a plurality of prisms.

6. The display device of claim 5, wherein the prisms include two-dimensional bars with a triangular cross-section.

7. The display device of claim 5, wherein the prisms include pyramids.

8. The display device of claim 1, wherein the at least one light management feature includes a transflective film.

9. The display device of claim 1, wherein the at least one light management feature includes a polarizing film.

10. The display device of claim 1, wherein the at least one light management feature includes first and second light management features.

11. The display device of claim 10, wherein the first and second light management features are each selected from a group consisting of a brightness enhancement film, a reflective film, a transflective film, a polarizing film, and a light diffusing film.

12. The display device of claim 11, wherein the first and second light management features are different types of light management features.

13. The display device of claim 11, wherein the first and second light management features are the same of type of light management feature.

14. The display device of claim 13, wherein the first light management feature is a first brightness enhancement films, and wherein the second light management feature is a second brightness enhancement film.

15. The display device of claim 14, wherein the first brightness enhancement film has a cross-sectional shape different than a cross-sectional shape of the second brightness enhancement film.

16. The display device of claim 14, wherein the first brightness enhancement film has an orientation different than an orientation of the second brightness enhancement film.

17. The display device of claim 14, wherein the first brightness enhancement film has a protrusion size different than a protrusion size of the second brightness enhancement film.

18. The display device of claim 10, wherein the first and second light management features are on opposite respective sides of the first panel.

19. The display device of claim 1, wherein the light emitting structure includes an anode, a cathode, and a light emitting material between the anode and the cathode.

20. The display device of claim 19, wherein the light emitting material includes a polymer emitter.

21. The display device of claim 20, wherein the polymer emitter includes a blend of light emitting polymers.

22. The display device of claim 21, wherein the blend of light emitting polymers is a miscible blend of light emitting polymers.

23. The display device of claim 21, wherein the blend of light emitting polymers is an immiscible blend of light emitting polymers.

24. The display device of claim 21, wherein the blend of light emitting polymers collectively produces white light.

25. The display device of claim 19, wherein the light emitting material includes an organic emitter.

26. The display device of claim 19, wherein the light emitting material includes a monochrome emitter.

27. The display device of claim 19, wherein the light emitting material includes plural emitters, at least one of which emits different colored light than another of the emitters.

28. The display device of claim 27, wherein the plural emitters includes first, second, and third emitters.

29. The display device of claim 28, wherein the first emitter emits blue light, the second emitter emits red light, and the third emitter emits green light.

30. The display device of claim 27, wherein the plural light emitters are stacked one on top of another.

31. The display device of claim 27; wherein the plural light emitters are arranged side by side.

32. The display device of claim 31, wherein the plural light emitters are arranged as alternating stripes of different of the light emitters.

33. The display device of claim 19, wherein the light emitting material includes a hole transport material.

34. The display device of claim 33, wherein the hole transport material has a thickness from 100 to 500 Angstroms.

35. The display device of claim 34, wherein the light emitting material further includes an electron transport material.

36. The display device of claim 35, wherein the electron transport material has a thickness from 100 to 500 Angstroms.

37. The display device of claim 33, wherein the light emitting material does not include an electron transport material.

38. The display device of claim 33, wherein the light emitting material further includes an emitter.

39. The display device of claim 37, wherein the emitter has a thickness from 50 to 100 Angstroms.

40. The display device of claim 33, wherein the light emitting material includes a semiconductor material.

41. The display device of claim 33, wherein the light emitting material includes an organic compound.

42. The display device of claim 33, wherein the light emitting material includes a light emitting polymer.

43. The display device of claim 42, wherein the light emitting polymer has a thickness from 20 to 60 nm.

44. The display device of claim 1, wherein the at least one light management feature is microreplicated onto the first panel.

45. The display device of claim 1, wherein the first panel is substantially transparent.

46. The display device of claim 45, wherein the first panel is in contact with the light control device.

47. The display device of claim 1, wherein the light management feature is on a side of the first panel that is closest to the light control device.

48. The display device of claim 1, wherein the light management feature is on a side of the first panel that is farthest to the light control device.

49. The display device of claim 1, wherein the first panel is a flexible panel.

50. The display device of claim 1, wherein the first panel is a rigid panel.

51. The display device of claim 1, wherein the second panel is a flexible panel.

52. The display device of claim 1, wherein the second panel is a rigid panel.

53. The display device of claim 1, wherein the first panel is made of a polymer material.

54. The display device of claim 1, wherein the first panel is made of glass.

55. The display device of claim 1, wherein the second panel is made of a polymer material.

56. The display device of claim 1, wherein the second panel is made of glass.

57. The display device of claim 1, wherein the light control device is a liquid crystal display.

58. The display device of claim 1, wherein the light management feature is on a side of the first panel that is closest to the light control device, and wherein the first panel includes spacers on a side that is farthest from the light control device.

59. The display device of claim 58, wherein the spacers define gaps between the first panel and the light emitting structure, and further comprising an inert gas in the gaps.

60. The display device of claim 58, wherein the spacers are a brightness enhancement film.

61. The display device of claim 1, wherein the second panel includes a reflective film.

62. The display device of claim 1, wherein the light control device is a first light control device, and further comprising a second light control device coupled to the backlight on an opposite side of the backlight from the first light control device.

63. The display device of claim 62, wherein the second panel also includes at least one light management feature.

64. The display device of claim 62, wherein the first and second panels are both transparent.

65. The display device of claim 62, wherein the light emitting structure includes an anode, a cathode, and a light emitting material between the anode and the cathode, and wherein the anode and the cathode are substantially transparent.

66. A method of making a display device, the method comprising:
forming a backlight, including:
forming a light management feature on a first panel;
forming a light emitting structure;
adhering a second panel to the first panel, with the light emitting structure therebetween; and
coupling the backlight to a light control device.

67. The method of claim 66, wherein the forming the light emitting structure includes forming the light emitting structure upon the first panel.

68. The method of claim 66, wherein the forming the light emitting structure includes forming the light emitting structure upon the second panel.

69. The method of claim 66, wherein the adhering the second panel to the first panel includes placing the panels together in a pick and place operation.

70. The method of claim 69, wherein one of the panels is a rigid panel, and the other of the panels is a flexible panel, and wherein the placing the panels together includes using a pick and place device to place the rigid panel on a web that includes the flexible panel.

71. The method of claim 70, wherein the first panel is the flexible panel and the second panel is the rigid panel.

72. The method of claim 71, wherein the forming the light management feature includes microreplicating protrusions on the first panel.

73. The method of claim 72, wherein the microreplicating protrusions includes microreplicating prism-shaped protrusions.

74. The method of claim 66, wherein the adhering the first panel and the second panel includes placing the panels together in a roll operation.

75. The method of claim 74, wherein the panels are both flexible panels.

76. The method of claim 66, wherein the forming the light emitting structure includes:
depositing a first electrode on one of the panels;
depositing a light emitting material on the first electrode; and
depositing a second electrode on the light emitting material.

77. The method of claim 66, wherein the coupling includes adhering the light management feature to the light control device.

78. A display device comprising:
a light control device having a plurality of picture elements; and
a backlight coupled to the light control device, wherein the backlight includes:
a first panel that includes a first light management feature;
a second panel that includes a second light management feature, wherein the second panel is sealingly adhered to the first panel; and
a light emitting structure between the first and second panels.

79. The display device of claim 78, wherein at least one of the light management features includes a brightness enhancement film.

80. The display device of claim 78, wherein at least one of the light management features includes a polarizing film.

81. The display device of claim 78, wherein at least one of the light management features includes a reflective film.

82. The display device of claim 78, wherein the first and second light management features are each selected from a group consisting of a brightness enhancement film, a reflective film, a transflective film, a polarizing film, and a light diffusing film.

83. The display device of claim 82, wherein the first and second light management features are different types of light management features.

84. The display device of claim 83, wherein one of the light management features is a brightness enhancement film, and the other of the light management features is a reflective film.

85. The display device of claim 78, wherein the light emitting structure includes an anode, a cathode, and a light emitting material between the anode and the cathode.

86. The display device of claim 85, wherein the light emitting material includes a polymer emitter.

87. The display device of claim 85, wherein the light emitting material includes an organic emitter.

88. The display device of claim 78, wherein the first panel is substantially transparent.

89. The display device of claim 88, wherein the first panel is in contact with the light control device.

90. The display device of claim 78, wherein the first panel is a flexible panel.

91. The display device of claim 78, wherein the second panel is a flexible panel.

92. The display device of claim 78, wherein the first panel and the second panel are both flexible panels.

93. The display device of claim 78, wherein the light control device is a liquid crystal display.

94. The display device of claim 78, wherein the light management feature is on a side of the first panel that is closest to the light control device, and wherein the first panel includes spacers on a side that is farthest from the light control device.

95. The display device of claim 94, wherein the spacers define gaps between the first panel and the light emitting structure, and further comprising an inert gas in the gaps.

96. The display device of claim 94, wherein the spacers are a brightness enhancement film.
